(19) United States
(12) Patent Application Publication
(10) Pub. No.: US 2025/0354751 A1
(43) Pub. Date: Nov. 20, 2025

(54) REFRIGERATOR AND METHOD OF CONTROLLING THE SAME

(71) Applicant: SAMSUNG ELECTRONICS CO., LTD., Suwon-si (KR)

(72) Inventor: Heejun KANG, Suwon-si (KR)

(21) Appl. No.: 19/069,560

(22) Filed: Mar. 4, 2025

Related U.S. Application Data
(63) Continuation of application No. PCT/KR2025/001989, filed on Feb. 11, 2025.

(30) Foreign Application Priority Data
May 20, 2024 (KR) 10-2024-0065261

(51) Int. Cl. F25D 29/00; F25D 23/02; G06F 3/01; G06V 10/26; G06V 40/20

(52) U.S. Cl. CPC F25D 29/00; F25D 23/028; G06F 3/017; G06V 10/26; G06V 40/28; F25D 2700/04

(57) ABSTRACT

An example method for controlling a refrigerator including at least one door, a door control module, a proximity sensor, and a camera sensor is provided. The method includes activating the camera sensor based on identifying that a user is positioned within a first distance from the refrigerator using the proximity sensor, obtaining an input image via the camera sensor based on identifying that the user is positioned within a second distance shorter than the first distance from the refrigerator using the proximity sensor, identifying a hand image corresponding to a hand of the user from the input image, performing pre-processing on the hand image, determining a hand gesture of the user from the hand image, and opening a door of the at least one door selected based on a gesture responsive to determining that the hand gesture is the gesture for selecting the door to be opened.

### CROSS-REFERENCE TO RELATED APPLICATIONS

This application is a continuation application of International Application No. PCT/KR2025/001989 designating the United States, filed on Feb. 11, 2025, in the Korean Intellectual Property Receiving Office, which claims priority from Korean Patent Application No. 10-2024-0065261, filed on May 20, 2024, in the Korean Intellectual Property Office, the disclosures of which are hereby incorporated by reference herein in their entireties.

### BACKGROUND

### Field

Various embodiments of the disclosure relate to a refrigerator, and more particularly, to a refrigerator that automatically opens at least one door and a method for controlling the refrigerator.

### Description of Related Art

A refrigerator is a device that stores objects such as food in a fresh state using a refrigeration cycle, and may include a freezing chamber that stores objects in a sub-zero temperature state, and a refrigerating chamber that stores objects in an above-freezing temperature state.

With the recent spread of smart homes and the development of Internet of Things (IoT) technology, refrigerators may perform various innovative functions, such as voice control, remote control via a smartphone app, and food management using internal cameras.

Meanwhile, the refrigerator may include at least one door according to the number or structure of storage compartments, such as the refrigerating chamber and/or the freezing chamber. The doors of the refrigerator may be used to put objects in the storage compartment or take them out. The doors of the refrigerator are closed to prevent leakage of cold air out of the storage compartment, keeping the temperature inside the storage compartment constant.

The opening of the door of the refrigerator is performed by the user's separate manipulation based on a physical contact. There are smart refrigerators capable of automatic door opening based on the user's intention without physical contact.

### SUMMARY

Various embodiments of the disclosure may provide a refrigerator and a control method thereof in which the user automatically opens a door that meets the intention by detecting the user's hand simultaneously using an infrared (IR) camera and a red-blue-green (RGB) camera and clearly grasping the structural information about the user's hand via pre-processing on a hand image.

According to embodiments of the disclosure, a refrigerator may comprise at least one storage compartment, at least one door for opening/closing the at least one storage compartment, a door control module for controlling to open or close the at least one door, a sensor unit including a proximity sensor and a camera sensor, at least one processor including processing circuitry, and a memory including one or more storage mediums storing instructions that, when executed by at least one processor individually or collectively, cause the refrigerator to perform operations. The operations may include activating the camera sensor based on identifying that a user is positioned within a first distance from the refrigerator using the proximity sensor, obtaining an input image via the camera sensor based on identifying that the user is positioned within a second distance shorter than the first distance from the refrigerator using the proximity sensor, identifying a hand image corresponding to a hand of the user from the input image, performing pre-processing on the hand image, determining a hand gesture of the user from the hand image, and controlling the door control module to open a door of the at least one door selected responsive to a first gesture based on determining that the hand gesture is the first gesture for selecting a door to be opened.

According to embodiments of the disclosure, a method for controlling a refrigerator may comprise activating a camera sensor based on identifying that a user is positioned within a first distance from the refrigerator using a proximity sensor, obtaining an input image via the camera sensor based on identifying that the user is positioned within a second distance shorter than the first distance from the refrigerator using the proximity sensor, identifying a hand image corresponding to a hand of the user from the input image, performing pre-processing on the hand image, determining a hand gesture of the user from the hand image, and opening a door of the at least one door selected based on a gesture responsive to determining that the hand gesture is the gesture for selecting the door to be opened.

According to various embodiments of the disclosure, the refrigerator of the disclosure may detect the user's hand simultaneously using an IR camera and an RGB camera, thereby recognizing the user's hand with high accuracy in various environments. Further, the refrigerator of the disclosure may increase the accuracy of determining the user's hand gesture by clearly grasping the structural information about the user's hand via pre-processing on the hand image. Therefore, the refrigerator of the disclosure may increase the convenience and efficiency of using the refrigerator by automatically opening the door that meets the user's intention.

Effects achievable in example embodiments of the disclosure are not limited to the above-mentioned effects, but other effects not mentioned may be apparently derived and understood by one of ordinary skill in the art to which example embodiments of the disclosure pertain, from the following description. In other words, unintended effects in practicing embodiments of the disclosure may also be derived by one of ordinary skill in the art from example embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a front view illustrating a refrigerator according to an embodiment of the disclosure;

FIG. 2 is a perspective view illustrating an inside of a refrigerator according to an embodiment of the disclosure;

FIG. 3 is a block diagram illustrating a configuration of a refrigerator according to an embodiment of the disclosure;

FIG. 4 is an example view illustrating a door control module and a sensor unit of a refrigerator according to an embodiment of the disclosure;

FIG. 5 is an example view illustrating various arrangements of camera sensors according to an embodiment of the disclosure;

FIG. 6 is a flowchart illustrating operations of a refrigerator according to an embodiment of the disclosure;

FIG. 7 is a view illustrating an operation in which a proximity sensor senses the user's approach to the refrigerator according to an embodiment of the disclosure;

FIG. 8 is an example view illustrating a configuration of a camera sensor according to an embodiment of the disclosure;

FIG. 9 is an example view illustrating an operation of identifying a hand image from an input image by a refrigerator according to an embodiment of the disclosure;

FIG. 10 is an example view illustrating first pre-processing operation of a refrigerator according to an embodiment of the disclosure;

FIG. 11 is an example view illustrating second pre-processing of a refrigerator according to an embodiment of the disclosure;

FIG. 12 is an example view illustrating third pre-processing of a refrigerator according to an embodiment of the disclosure;

FIG. 13 is a view illustrating a process in which an artificial intelligence model determines the user's hand gesture from a hand image according to an embodiment of the disclosure;

FIG. 14 is a view illustrating an operation in which a refrigerator determines a door to be opened based on the position of the user's hand, according to an embodiment of the disclosure;

FIG. 15 is a view illustrating an identification notification for a first gesture and a second gesture according to an embodiment of the disclosure;

FIG. 16 is a view illustrating an identification notification for a first gesture and a third gesture according to an embodiment of the disclosure; and

FIG. 17 is a view illustrating a user device and a server connected to a refrigerator according to an embodiment of the disclosure.

### DETAILED DESCRIPTION

It should be appreciated that various embodiments of the disclosure and the terms used therein are not intended to limit the technological features set forth herein to particular embodiments and include various changes, equivalents, or replacements for a corresponding embodiment.

With regard to the description of the drawings, similar reference numerals may be used to refer to similar or related elements.

It is to be understood that a singular form of a noun corresponding to an item may include one or more of the things, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases.

As used herein, such terms as “1st” and “2nd,” or “first” and “second” may be used to simply distinguish a corresponding component from another, and does not limit the components in other aspect (e.g., importance or order).

It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

It will be further understood that the terms “comprise” and/or “have,” as used herein, specify the presence of stated features, integers, steps, operations, elements, and/or components, but do not preclude the presence or addition of one or more other features, integers, steps, operations, elements, components, and/or groups thereof.

It will be understood that when a component is referred to as “connected to,” “coupled to”, “supported on,” or “contacting” another component, the components may be connected to, coupled to, supported on, or contact each other directly or via a third component.

Throughout the specification, when one component is positioned “on” another component, the first component may be positioned directly on the second component, or other component(s) may be positioned between the first and second component.

The term “and/or” may denote a combination(s) of a plurality of related components as listed or any of the components.

Hereinafter, the working principle and embodiments of the disclosure are described with reference to the accompanying drawings.

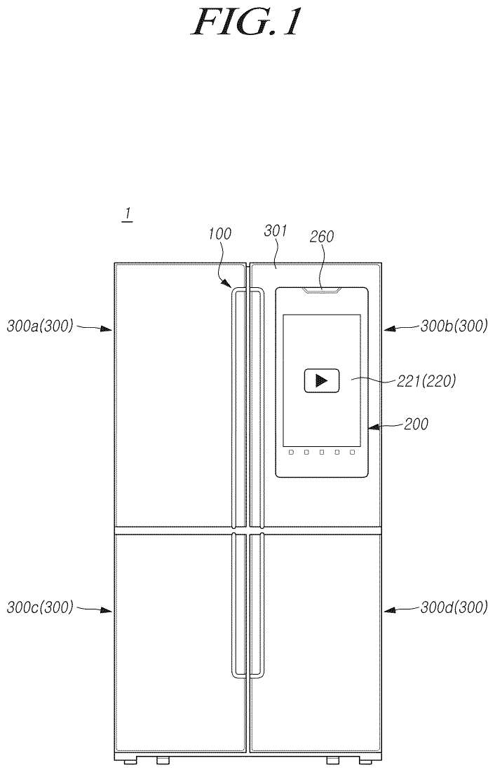

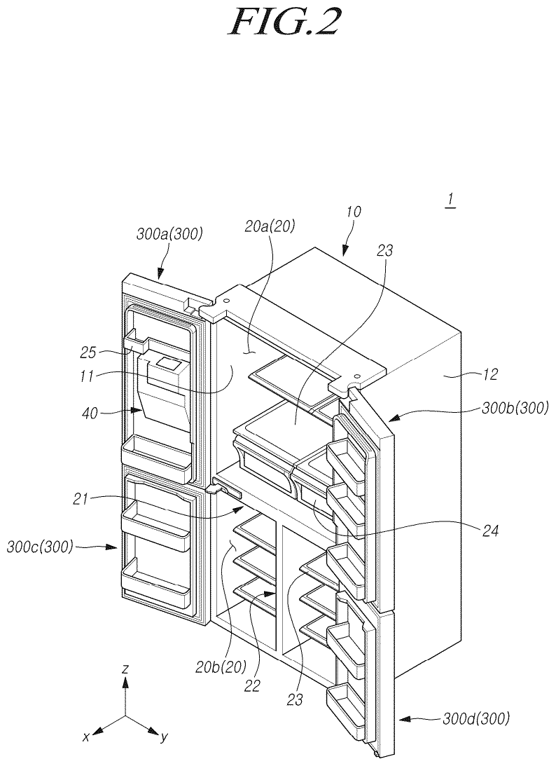

FIG. 1 is a front view illustrating a refrigerator 1 according to an embodiment of the disclosure. FIG. 2 is a perspective view illustrating an inside of a refrigerator 1 according to an embodiment of the disclosure.

The refrigerator 1 may include a main body 10, a storage compartment provided inside the main body 10 to have an open front surface, and a door 300 rotatably coupled to the main body 10 to open and close the open front surface of the storage compartment.

The main body 10 may form an outer appearance of the refrigerator 1. The main body 10 may include an inner case 11 forming a storage compartment, and an outer case 12 coupled to the outside of the inner case 11 to form an outer appearance. Further, the main body 10 may further include a cold air supply device (not shown) for supplying cold air to the storage compartment.

The cold air supply device may include a compressor, a condenser, an expansion valve, an evaporator, a blower fan, a cold air duct, or the like. An insulation material (not shown) may fill between the inner case 11 and the outer case 12 of the main body 10 to prevent cold air from leaking out of the storage compartment.

A machine (not shown) in which a compressor for compressing the refrigerant and a condenser for condensing the compressed refrigerant are installed may be provided on a lower rear side of the main body 10.

The storage compartment 20 may be divided into a plurality of storage compartments by a horizontal partition wall 21 and a vertical partition wall 22. In the present embodiment, the storage compartment 20 may include an upper storage compartment 20a and a lower storage compartment 20b. In the storage compartment 20, a shelf 23 on which food may be placed and a sealed container 24 for hermetically storing food may be provided. The storage compartment 20 is provided to have an open front surface so that food may be taken in and out, and the open front surface may be opened and closed by the door 300.

The upper storage compartment 20a may be opened and closed by a plurality of doors 300a and 300b. The lower storage compartment 20b may be opened and closed by a plurality of doors 300c and 300d.

The refrigerator 1 may further include a handle 100 provided on the door 300. The user may easily open and close the door 300 by holding the handle 100. The handle 100 may be elongated along the vertical direction Z of the door 300.

The refrigerator 1 may further include a dispenser (not shown). The dispenser may be installed in the door 300. As an example, the dispenser may be installed in the left upper door 300a. Through the dispenser, the user may directly dispense water or ice to the outside without opening the door 300a. The dispenser may include a cavity recessed inward of the door 300a to form a dispensing space. The cavity may be provided with an outlet through which water or ice is dispensed, and a dispensing lever by which water or ice is dispensed. If the dispensing lever is pressurized, water or ice is dispensed from the outlet. The dispenser may further include a dispenser status display window for displaying the operation state of the dispenser. The dispenser status display window may have a touch function.

In an embodiment, the refrigerator 1 may further include a display 200.

The display 200 may be installed on the door 300 for the user's convenience. Specifically, the display 200 may be installed on the front surface 301 of the door 300.

Hereinafter, a case where the display 200 is installed on the right upper door 300b is illustrated, but the position is not limited to the right upper door 300b as long as the display 200 may be installed on the door 300. However, the following description focuses primarily on a case where the display 200 is installed on the right upper door 300b.

The upper end portion of the display 200 may be placed at the same position as the upper end portion of the handle 100 in the vertical direction Z of the door 300.

The lower end portion of the display 200 may be positioned at the same position as the lower end portion of the dispenser 40 in the vertical direction Z of the door 300. One side end portion of the display 200 adjacent to the handle 100 may be spaced apart from the handle 100 by a certain interval. The other side end portion, facing the one side end portion, of the display 200 adjacent to the handle 100 may be spaced apart from the edge of the door 300 by a certain interval.

In another aspect, the display 200 may have a rectangular shape having a longer side in the vertical direction Z of the door 300 (e.g., a portrait orientation). The display 200 may include a right long side facing the right side of the door 300, a left long side facing the left side of the door 300, an upper short side facing the upper side of the door 300, and a lower short side facing the lower side of the door 300.

The right long side may be spaced apart from the right edge of the door 300 by a certain interval in the left direction of the door 300. The left long side may be spaced apart from the handle 100 by a certain interval in the right direction of the door 300. The upper short side may be positioned at the same position as the upper end portion of the handle 100 in the vertical direction Z of the door 300. The lower short side may be positioned at the same position as the lower end portion of the dispenser 40 in the vertical direction Z of the door 300.

Through the arrangement of the display 200, it is possible to implement a neat and stable design of the refrigerator 1.

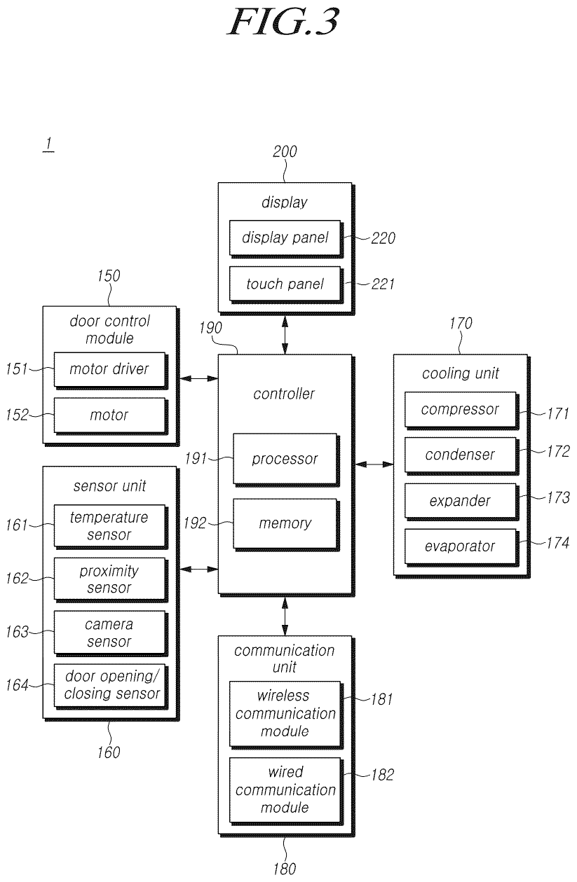

The display 200 may include a display panel 220 and a touch panel 221. However, the display 200 may include only the display panel 220 according to one or more embodiments. The display 200 may have a wake-up function that is automatically activated when the user approaches within a certain range. For example, the wake-up function may be implemented through a proximity sensor (e.g., the proximity sensor 162 of FIG. 3).

Specifically, if the proximity sensor 162 detects the user's approach within a certain range, the display 200 may be activated. In other words, the display 200 may be turned on. Conversely, if the proximity sensor 162 does not detect the user's approach within the predetermined range, the display 200 may not be activated. In other words, the display 200 may be maintained in an off state. If the display 200 is activated, various videos or images may be displayed on the display 200.

For example, the display 200 may have a function of pausing video playback and turning off the power of the display 200 if the user opens the door equipped with the display 200. Further, the display 200 may have a function of resuming video playback and turning on the power of the display 200 if the user closes the door equipped with the display 200. For example, the power-off/on function of the display 200 may be implemented through a door opening/closing sensor (e.g., the opening/closing sensor 164 of FIG. 3).

The display 200 may include a display panel 220. The display 200 may include a liquid crystal display (LCD). The display panel 220 may be positioned on the front surface of the display. The touch panel 221 may be formed on the display panel 220.

The user may play or pause video by touching the touch panel 221. The touch panel 221 may be implemented in a capacitive type or a resistive type. However, the method for forming the touch panel 221 is not limited to the above-described example.

At least one input user interface (UI) component may be provided on the display panel 220. The at least one input UI component may include, e.g., a camera UI component executing a camera (e.g., the camera sensor 163 of FIG. 3), a list UI component listing various lists related to the function of the refrigerator 1, a home UI component returning to the start screen, a return UI component returning to the pre-execution stage, an information providing UI component providing information about the overall function of the refrigerator 1 or the overall function of the display 200, or the like.

At least one input UI component may be formed on the display panel 220. Preferably, at least one input UI component may be formed in an outer area of the display panel 220 so as not to interfere with an image or video displayed on the display 200.

The refrigerator 1 may further include a camera sensor 163 capable of photographing a person or a thing. For example, an image or video captured by the camera sensor 163 may be displayed on the display 200.

The refrigerator 1 may further include at least one microphone for implementing a voice recognition function. A voice command input through at least one microphone is transferred to a processor (e.g., the processor 191 of FIG. 3), and the processor 191 controls the display 200 to display a voice command result.

The refrigerator 1 may further include an illuminance sensor (not shown). The illuminance sensor may adjust the lighting of the display to be brighter, such as in a bright place or during the day time, and adjust the lighting of the display to be darker, such as in a dark place or during the night time, to reduce the power consumption of the refrigerator 1. The detection result of the illuminance sensor is transferred to the processor 191, and the processor 191 controls the display panel 220 to adjust the luminance of the display 200.

The refrigerator 1 may include a door opening/closing sensor (e.g., the door opening/closing sensor 164 of FIG. 3). The door opening/closing sensor 164 may be provided on a hinge (not shown) that couples the door 300 with the main body 10, or may be provided on a portion of the door 300 or on a portion of the main body 10 where the door 300 and the main body 10 contact.

At least one of the proximity sensor 162, the camera sensor 163, at least one microphone, and the illuminance sensor may be disposed on the front surface of the door 300. For example, at least one of the proximity sensor 162, the camera sensor 163, at least one microphone, and the illuminance sensor may detect a change in the front of the refrigerator 1 located in a direction X.

At least one of the proximity sensor 162, the camera sensor 163, at least one microphone, and the illuminance sensor may be disposed on the rear surface of the door 300. For example, at least one of the proximity sensor 162, the camera sensor 163, at least one microphone, and the illuminance sensor may detect a change in the inside (e.g., the storage compartment 20) of the refrigerator 1.

FIG. 3 is a block diagram illustrating a configuration of a refrigerator 1 according to an embodiment of the disclosure.

In FIG. 3, the refrigerator 1 may include a door control module 150, a sensor unit 160, a cooling unit 170, a communication unit 180, a controller 190, and a display 200.

The door control module 150 may control opening or closing of at least one door (e.g., at least one door 300 of FIG. 1). The door control module 150 may include a motor driver 151 and a motor 152. For example, the door control module 150 may precisely control the movement of at least one door 300 according to whether at least one door 300 is opened or the degree of opening.

The motor driver 151 may control the motor. For example, the motor driver 151 may activate or deactivate the motor 152. For example, the motor driver 151 may control the operation state of the motor 152 by supplying or cutting off power to the motor 152.

The motor 152 may open at least one door by rotating. For example, the motor 152 may be activated based on the control of the motor driver, thereby opening at least one door. For example, the motor 152 may be deactivated based on the control of the motor driver, thereby closing at least one door.

The sensor unit 160 may include a temperature sensor 161, a proximity sensor 162, a camera sensor 163, and a door opening/closing sensor 164.

The temperature sensor 161 may sense the temperature around the refrigerator 1 or inside the refrigerator 1. For example, the temperature sensor 161 may include a plurality of temperature sensors for sensing the temperature inside the storage compartment 20. For example, the temperature sensor 161 may include a plurality of temperature sensors for sensing the external temperature around the refrigerator 1.

For example, the plurality of temperature sensors may be installed in the plurality of storage compartments 20, respectively, to sense the temperature of each of the plurality of storage compartments 20 and output an electrical signal corresponding to the sensed temperature to the controller 190. Each of the plurality of temperature sensors may include a thermistor whose electrical resistance changes according to temperature.

The proximity sensor 162 may be a sensor that detects whether a distance to a person or a thing is close within a predetermined distance by detecting a change in distance from the person or the thing. For example, the proximity sensor 162 may identify the user's approach and detect the distance between the user and the refrigerator 1.

For example, the proximity sensor 162 may include at least one of an infrared sensor, an ultrasonic sensor, a capacitive sensor, and an inductive sensor.

The camera sensor 163 may be a sensor that generates a digital image by converting light collected in a sensing area into an electrical signal. For example, the camera sensor 163 may photograph objects around the refrigerator 1 or inside the refrigerator 1 and generate a digital image.

For example, the camera sensor 163 may include at least one of a complementary metal-oxide-semiconductor (CMOS) sensor, a charge-coupled device (CCD) sensor, an IR camera, and an RGB camera.

As described above, the door opening/closing sensor 164 may output whether the door 300 is opened or closed as a preset determination value. For example, the door opening/closing sensor 164 may output 1 if the door 300 is open and 0 if the door 300 is closed.

The door opening/closing sensor 164 may also be implemented as a distance sensor, and if the distance between the door 300 and the main body is more than a reference distance, it may determine that the door 300 is open, and if the distance is less than the reference distance, determine that the door 300 is closed.

However, the door opening/closing sensor 164 is not limited thereto, but is not limited in its configuration as long as it may determine whether the door 300 is open and output it as a preset determination value.

The cooling unit 170 may supply cooled air to the storage compartment. Specifically, the cooling unit 170 may maintain the temperature of the storage compartment within a range designated by the user using the circulation of the refrigerant in the refrigerant circuit.

The cooling unit 170 may include a compressor 171 for compressing the gaseous refrigerant, a condenser 172 for converting the compressed gaseous refrigerant into a liquid state, an expander 173 for decompressing the liquid refrigerant, and an evaporator 174 for converting the decompressed liquid refrigerant into a gaseous state. The cooling unit 170 may cool the air in the storage compartment using the phenomenon in which the liquid refrigerant absorbs thermal energy of the surrounding air while converting to the gaseous state.

However, the cooling unit 170 is not limited as including a refrigerant circuit. For example, the cooling unit 170 may include a Peltier element using the Peltier effect or a magnetic cooling material using a magnetic thermal effect.

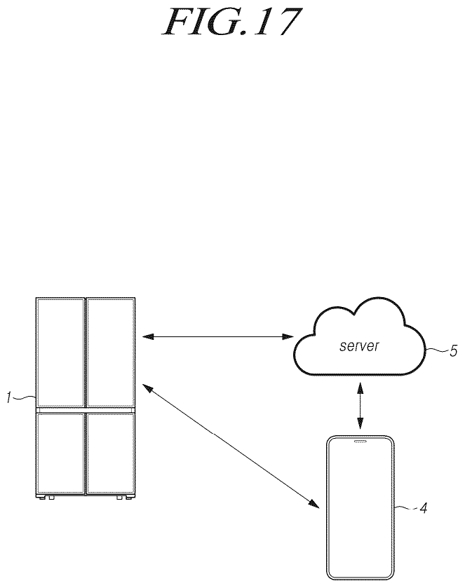

The communication unit 180 may exchange data with external devices such as a server device (e.g., the server 5 of FIG. 17) and/or a user device (e.g., the user device 4 of FIG. 17), and/or the display 200 and/or a cooking device (e.g., an oven or microwave oven).

The communication unit 180 may include a wired communication module 182 for wiredly exchanging data with external devices and a wireless communication module 181 for wirelessly exchanging data with external devices.

The wired communication module 182 may access a wired communication network and communicate with external devices through the wired communication network. For example, the wired communication module 182 may access the wired communication network through Ethernet (Ethernet, IEEE 802.3 technology standard) and receive data from the external devices through the wired communication network.

The wireless communication module 181 may wirelessly communicate with a base station or an access point (AP), and may access the wired communication network through the base station or the access point. The wireless communication module 181 may also communicate with the external devices connected to the wired communication network via the base station or the access point. For example, the wireless communication module 181 may wirelessly communicate with the access point (AP) using Wi-Fi (IEEE 802.11 technology standard), or communicate with the base station using CDMA, WCDMA, GSM, long term evolution (LET), or Wi-Bro. The wireless communication module 181 may also receive data from the external devices via the base station or the access point. Further, the wireless communication module 181 may directly communicate with the external devices. For example, the wireless communication module 181 may receive data wirelessly from the external devices using Wi-Fi, Bluetooth (IEEE 802.15.1 technology standard), ZigBee (IEEE 802.15.4 technology standard), etc.

As such, the communication unit 180 may transmit or receive data with the external devices, and in particular, may receive video data including video and/or audio from the external devices and output the received data to the controller 190.

The controller 190 may process user input and/or door opening/closing detection data and/or communication data, and control the components included in the refrigerator 1 based on data processing. According to an embodiment, the controller 190 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor,” “at least one processor,” and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The controller 190 may include a memory 192 including one or more storage mediums that stores/records programs and/or data, and a processor 191 that processes user input and/or door opening/closing detection data and/or communication data according to the program and/or data stored in the memory 192.

The memory 192 may store/memory a program and/or data. The program includes a plurality of instructions combined to perform a specific function, and the data may be processed and/or treated by a plurality of instructions included in the program. Further, the program and/or data may include system programs and/or system data directly related to the operation of the refrigerator 1, and application programs and/or application data that provide convenience to the user.

The memory 192 may include a non-volatile memory storing a program and/or data for controlling the components included in the refrigerator 1 and a volatile memory storing temporary data generated during controlling the components included in the refrigerator 1.

The non-volatile memory, for example, may store programs and/or data electrically, magnetically, or optically. The non-volatile memory may include, e.g., a read only memory or flash memory for storing data for a long time. The non-volatile memory may also include a solid state drive (SSD), a hard disk drive (HDD), or an optical disc drive (ODD).

The volatile memory may load the program and/or data from the non-volatile memory, e.g., and may electrically store the program and/or data. The volatile memory may include, e.g., static random access memory (S-RAM) and dynamic random access memory (D-RAM) for temporarily storing data.

The memory 192 may store/record programs and data such as operating systems (OS), middleware, and applications, and may provide the programs and data to the processor 191 in response to a request of the processor 191.

The processor 191 may process a user input of the display 200 and detection data of the proximity sensor 162 and/or communication data of the communication unit 180 according to the program and/or data stored/recorded in the memory 192. Further, the processor 191 may generate a control signal for controlling the operation of the camera sensor 163, display 200, and/or communication unit 180 based on data processing.

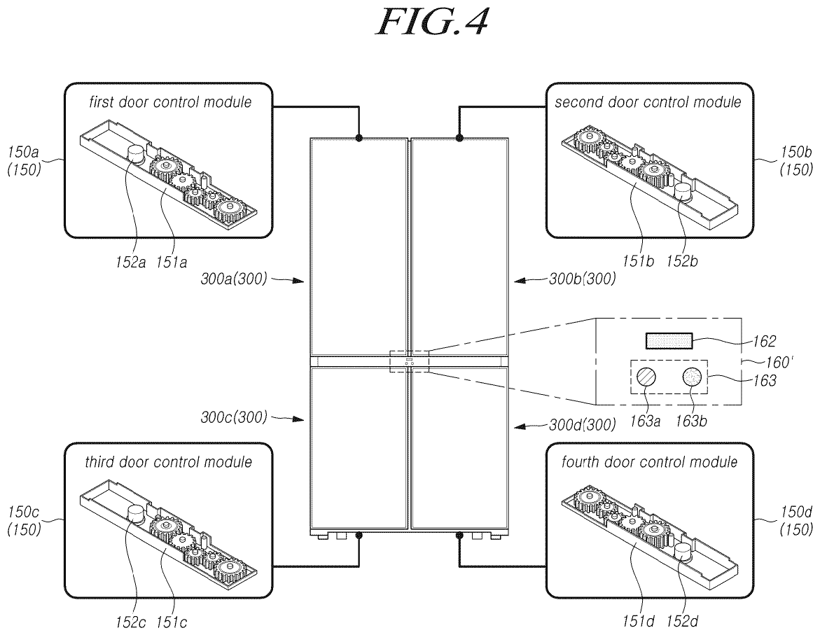

FIG. 4 is an example view illustrating a door control module 150 and a sensor unit 160 of a refrigerator 1 according to an embodiment of the disclosure.

In FIG. 4, the refrigerator 1 may include a door control module 150 and a sensor unit 160. The door control module 150 and the sensor unit 160 may be formed at predetermined positions of the refrigerator 1 according to their respective functions.

The door control module 150 may control opening or closing of at least one door. The door control module 150 may include a motor driver 151 and a motor 152. For example, the door control module 150 may precisely control the movement of at least one door 300 according to whether at least one door 300 is opened or the degree of opening.

The motor driver 151 may control the motor. For example, the motor driver 151 may activate or deactivate the motor 152. For example, the motor driver 151 may control the operation state of the motor 152 by supplying or cutting off power to the motor 152.

The motor 152 may open at least one door by rotating. For example, the motor 152 may be activated based on the control of the motor driver, thereby opening at least one door. For example, the motor 152 may be deactivated based on the control of the motor driver, thereby closing at least one door.

As shown in FIG. 4, the door control module 150 may include a first door control module 150a, a second door control module 150b, a third door control module 150c, and a fourth door control module 150d corresponding to at least one door 300. Each of the first door control module 150a to the fourth door control module 150d may include a motor driver 151 (e.g., motor drivers 151a, 151b, 151c, 151d) and a motor 152 (e.g., motors 152a, 152b, 152c, 152d) for controlling the opening and closing of at least one door 300.

The first door control module 150a may be formed on an upper frame adjacent to the left upper door 300a to control opening or closing of the left upper door 300a. For example, the first motor driver 151a may control the opening or closing of the left upper door 300a by receiving a door control signal from the processor 191 and activating or deactivating the first motor 152a based on the door control signal.

The second door control module 150b may be formed on an upper frame adjacent to the right upper door 300b to control opening or closing of the right upper door 300b. For example, the second motor driver 151b may control the opening or closing of the right upper door 300b by receiving a door control signal from the processor 191 and activating or deactivating the second motor 152b based on the door control signal.

The third door control module 150c may be formed on a lower frame adjacent to the left lower door 300c to control opening or closing of the left lower door 300c. For example, the third motor driver 151c may control the opening or closing of the left lower door 300c by receiving a door control signal from the processor 191 and activating or deactivating the third motor 152c based on the door control signal.

The fourth door control module 150d may be formed on a lower frame adjacent to the right lower door 300d to control opening or closing of the right lower door 300d. For example, the fourth motor driver 151d may control the opening or closing of the right lower door 300d by receiving a door control signal from the processor 191 and activating or deactivating the fourth motor 152d based on the door control signal.

The sensor unit 160 may include a temperature sensor 161, a proximity sensor 162, a camera sensor 163, and a door opening/closing sensor 164. FIG. 4 illustrates a sensor group 160′ including some components of the sensor unit 160. For example, the sensor group 160′ may include a proximity sensor 162 and a camera sensor 163.

The proximity sensor 162 may be a sensor that detects whether a distance to a person or an object is close within a predetermined distance by detecting a change in distance from a person or an object. For example, the proximity sensor 162 may identify the user's approach and detect the distance between the user and the refrigerator 1.

The camera sensor 163 may be a sensor that generates a digital image by converting light collected in a sensing area into an electrical signal. For example, the camera sensor 163 may photograph objects around the refrigerator 1 or inside the refrigerator 1 and generate a digital image.

In the disclosure, the camera sensor 163 may include an IR camera 163a and an RGB camera 163b. For example, the camera sensor 163 may use both the IR camera 163a and the RGB camera 163b to photograph objects around the refrigerator 1 and generate digital images. In particular, the camera sensor 163 of the disclosure simultaneously uses the IR camera 163a and the RGB camera 163b to detect the user's hand, so that the user's hand may be recognized with high accuracy even in various environments.

For example, the proximity sensor 162 is a sensor separate from the camera sensor 163 and may be independently disposed. For example, the proximity sensor 162 and the camera sensor 163 may be disposed adjacent to each other as one set. FIG. 4 illustrates a case in which the proximity sensor 162 and the camera sensor 163 are disposed adjacent to each other as one sensor group 160′.

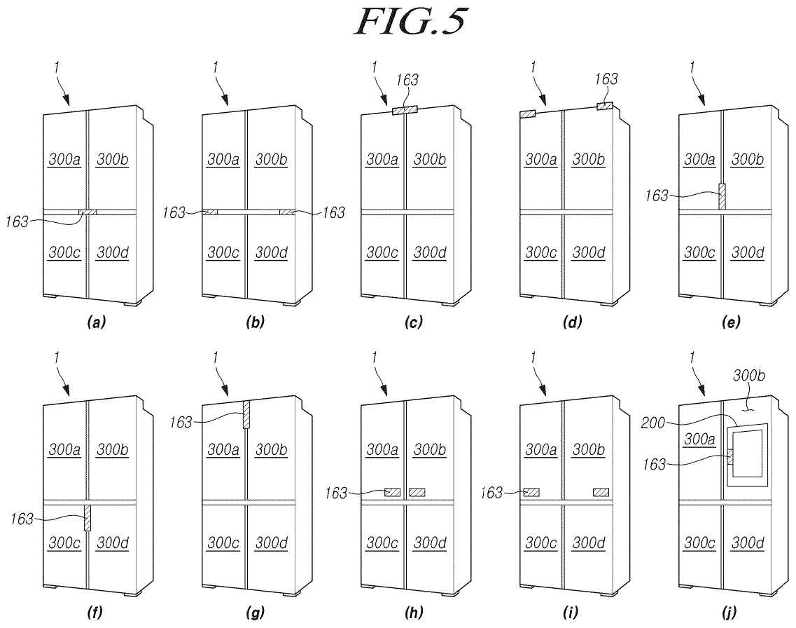

In an embodiment, the camera sensor 163 may be formed at various positions of the refrigerator 1. Various arrangements of the camera sensor 163 of the refrigerator 1 are described below with reference to FIG. 5.

FIG. 5 is an example view illustrating various arrangements of camera sensors 163 according to an embodiment of the disclosure.

In FIG. 5, the camera sensor 163 may be formed at various positions on the refrigerator 1 to effectively photograph objects around the refrigerator 1. For example, the camera sensor 163 may be formed between the upper doors 300a and 300b and the lower doors 300c and 300d of the refrigerator 1. For example, the camera sensor 163 may be formed on the upper frame of the refrigerator 1. For example, the camera sensor 163 may be formed between the left doors 300a and 300c and the right doors 300b and 300d of the refrigerator 1. For example, the camera sensor 163 may be formed on the front surface of at least one door. For example, the camera sensor 163 may be formed in a partial area of the display.

As shown in FIG. 5(a) and FIG. 5(b), the camera sensor 163 may be formed between the upper doors 300a and 300b and the lower doors 300c and 300d of the refrigerator 1. For example, the camera sensor 163 may be formed in the center between the upper doors 300a and 300b and the lower doors 300c and 300d of the refrigerator 1. For example, one of the plurality of camera sensors 163 may be formed on the left side between the upper doors 300a and 300b and the lower doors 300c and 300d of the refrigerator 1, and the other camera sensor 163 may be formed on the right side between the upper doors 300a and 300b and the lower doors 300c and 300d of the refrigerator 1. When the camera sensor 163 is formed between the upper doors 300a and 300b and the lower doors 300c and 300d of the refrigerator 1, the camera sensor 163 may recognize and identify the hand facing the upper doors 300a and 300b and the hand facing the lower doors 300c and 300d with high accuracy.

As shown in FIG. 5(c) and FIG. 5(d), the camera sensor 163 may be formed on an upper frame of the refrigerator 1. For example, the camera sensor 163 may be formed in the center of the upper frame of the refrigerator 1. For example, one of the plurality of camera sensors 163 may be formed on the left side of the upper frame of refrigerator 1, and the other camera sensor 163 may be formed on the right side of the upper frame of refrigerator 1. When the camera sensor 163 is formed on the upper frame of the refrigerator 1, the camera sensor 163 may identify and recognize the user's hand facing the refrigerator 1 with high accuracy based on a wide viewing angle.

As shown in 5(e), 5(f), and 5(g), the camera sensor 163 may be formed between the left doors 300a and 300c and the right doors 300b and 300d of the refrigerator 1. For example, the camera sensor 163 may be formed between the left upper door 300a and the right upper door 300b of the refrigerator 1. For example, the camera sensor 163 may be formed between the left lower door 300c and the right lower door 300d of the refrigerator 1. For example, the camera sensor 163 may be formed between the left doors 300a and 300c and the right doors 300b and 300d of the refrigerator 1 to be connected to the upper frame of the refrigerator 1. When the camera sensor 163 is formed between the left doors 300a and 300c and the right doors 300b and 300d of the refrigerator 1, the camera sensor 163 may recognize and identify the hand facing the left doors 300a and 300c and the hand facing the right doors 300b and 300d with high accuracy.

As shown in FIG. 5(h) and FIG. 5(i), the camera sensor 163 may be formed on the front surface of at least one door. For example, the at least one door may include at least one hole through which the camera sensor 163 may photograph the object in front of the door. For example, at least one door may be made of glass, or partially made of glass, or other transparent or semi-transparent material, where the camera sensor 163 may photograph the object in front of the door. When the camera sensor 163 is formed on the front surface of at least one door, the camera sensor 163 may identify and recognize the user's hand facing the refrigerator 1 with high accuracy based on an increase in the sensing distance.

As shown in FIG. 5(j), the camera sensor 163 may be formed in a partial area of the display (e.g., the display 200 of FIG. 1). For example, the camera sensor 163 may be formed in a peripheral area (e.g., non-display area) of the display panel (e.g., the display panel 220 of FIG. 1). For example, the camera sensor 163 may be an under display camera (UDC) formed in the display area of the display panel (e.g., the display panel 220 of FIG. 1). When the camera sensor 163 is formed in the partial area of the display, the refrigerator 1 may provide a user-friendly user interface based on the interworking between the camera sensor 163 and the display.

Meanwhile, the arrangement of the camera sensor 163 included in the refrigerator 1 according to an embodiment of the disclosure is not limited to the positions shown in 5(a) to 5(j). Further, while only the camera sensor 163 included in the refrigerator 1 is illustrated in FIG. 5, the proximity sensor 162 may also be disposed at the same position as the camera sensor 163 or at a position adjacent to the camera sensor 163.

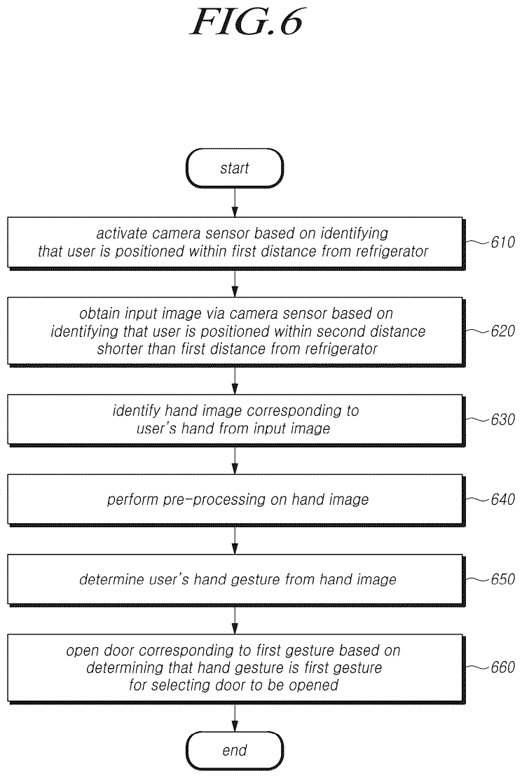

FIG. 6 is a flowchart illustrating operations of a refrigerator 1 according to an embodiment of the disclosure.

In FIG. 6, the refrigerator 1 of the disclosure may automatically open the door that meets the user's intention by simultaneously using the IR camera 163a and the RGB camera 163b to detect the user's hand and clearly grasp structural information about the user's hand via pre-processing on the hand image.

Specifically, the refrigerator 1 may activate the camera sensor 163 based on identifying that the user is positioned within a first distance D1 from the refrigerator 1 using the proximity sensor 162 (operation 610), obtaining an input image via the camera sensor 163 based on identifying that the user is positioned within a second distance D2 shorter than the first distance D1 from the refrigerator 1 using the proximity sensor 162 (operation 620), identifying a hand image corresponding to the user's hand from the input image (operation 630), performing pre-processing on the hand image (operation 640), determining the user's hand gesture from the hand image using at least one artificial intelligence model (operation 650), and opening a door selected based on a first gesture based on determining that the hand gesture is the first gesture for selecting a door to be opened (operation 660).

According to an example, in operation 610, the refrigerator 1 may activate the camera sensor 163 based on identifying that the user is positioned within the first distance D1 from the refrigerator 1 using the proximity sensor 162.

The proximity sensor 162 may detect whether the user is close to the refrigerator 1 within a predetermined distance by detecting a change in distance between the user and the refrigerator 1. The refrigerator 1 may activate the camera sensor 163 based on identifying that the user is positioned within the first distance D1 from the refrigerator 1. When the camera sensor 163 is activated, the camera sensor 163 may photograph the user within the first distance D1.

According to an example, in operation 620, the refrigerator 1 may obtain an input image via the camera sensor based on identifying that the user is positioned within the second distance D2 shorter than the first distance D1 from the refrigerator 1 using the proximity sensor 162. For example, the refrigerator 1 may obtain an input image using the camera sensor 163. The refrigerator 1 may sense the user's hand using the camera sensor 163.

The camera sensor 163 may photograph the user's hand within the second distance D2 from the refrigerator 1. The camera sensor 163 may sense the user's hand by simultaneously using the IR camera 163a and the RGB camera 163b. The IR camera 163a may be a camera sensor 163 that generates an input image by sensing an infrared spectrum. For example, the refrigerator 1 may generate a first input image by photographing the user's hand using the IR camera 163a. The RGB camera 163b may be a camera sensor 163 that detects red, green, and blue, which are the primary colors of light, and generates an input image based on each color. For example, the refrigerator 1 may generate a second input image by photographing the user's hand using the RGB camera 163b.

As such, the refrigerator 1 of the disclosure may increase the hand recognition rate by simultaneously using the IR camera 163a and the RGB camera 163b to sense the user's hand.

According to an example, in operation 630, the refrigerator 1 may identify the hand image corresponding to the user's hand from the input image obtained via the camera sensor 163. For example, the refrigerator 1 may identify the hand image corresponding to the user's hand from the first input image obtained from the IR camera 163a. For example, the refrigerator 1 may identify the hand image corresponding to the user's hand from the second input image obtained from the RGB camera 163b.

In an embodiment, the refrigerator 1 may generate a third input image by synthesizing the first input image obtained from the IR camera 163a and the second input image obtained from the RGB camera 163b. For example, the third input image may be an input image obtained by synthesizing the first input image and the second input image at the same ratio (e.g., one-to-one). The refrigerator 1 may identify the hand image corresponding to the user's hand from the third input image.

In an embodiment, the third input image may be an input image obtained by synthesizing the first input image and the second input image at different ratios. For example, the refrigerator 1 may synthesize the first input image and the second input image by applying a first weight to the first input image and a second weight to the second input image.

The first weight may increase as the ambient illuminance decreases. For example, since IR cameras may operate in environments where there is little light, the first weight applied to the first input image may increase as the ambient illuminance decreases.

The second weight may increase as the ambient illuminance increases. For example, since RGB cameras provide high resolution, the second weight applied to the second input image may increase as the ambient illuminance increases.

The refrigerator 1 may analyze the shape of the hand, the palm area, the finger length, the angle between fingers, distinguishing features of the hand (e.g., wrinkles, creases, scars, joint locations, etc.) or the like included in at least one of the first input image, the second input image, and the third input image. The refrigerator 1 may identify the hand image included in the input image by filtering the analyzed input image.

According to an example, in operation 640, the refrigerator 1 may pre-process the hand image. Before determining the hand gesture using an artificial intelligence model (described further herein), the refrigerator 1 may remove unnecessary noise from the hand image and emphasize important features of the hand image. For example, pre-processing on the hand image may include at least one of noise removal in the hand image, emphasis on main features of the hand, standardization and normalization of the hand image, and shape transformation of the hand image.

In an embodiment, the refrigerator 1 may perform first pre-processing for removing a background image from the input image while leaving the hand image. The refrigerator 1 may clearly determine the hand gesture by effectively removing all background elements from the input image while leaving the hand image via the first pre-processing.

In an embodiment, the refrigerator 1 may perform second pre-processing of emphasizing hand wrinkles, hand joints, and fingers by performing contrast correction on the hand image. The refrigerator 1 may clearly determine the hand gesture by generating an emphasis line EL representing the features of the detailed structure of the user's hand by contrast correction on the hand image via the second pre-processing.

In an embodiment, the refrigerator 1 may perform third pre-processing of generating a bounding line or a bounding box for the thickness, length, and direction of the finger. The refrigerator 1 may clearly determine the hand gesture by grasping the exact position and direction of the finger, palm, and back of the hand in the hand image via the third pre-processing.

As such, the refrigerator 1 of the disclosure may increase the determination accuracy of the hand gesture by performing pre-processing on the hand image.

According to an example, in operation 650, the refrigerator 1 may determine the user's hand gesture from the hand image using an artificial intelligence model (described further herein). For example, the refrigerator 1 may determine the hand gesture by inferring an intended gesture from the hand image using the artificial intelligence model that has learned the correlation between the hand image and the preset hand gesture.

The intended gesture may be a hand gesture implemented by the user via a hand by the user to provide a preset hand gesture (e.g., first gesture, second gesture, third gesture) to the refrigerator 1. The refrigerator 1 may infer the intended gesture from the hand image and determine the hand gesture (e.g., a first gesture, a second gesture, and a third gesture) intended to be provided by the user from the intended gesture.

The artificial intelligence model may determine the hand direction based on hand wrinkles, hand joints, and thumb positions. The artificial intelligence model may determine an unfolded finger or a folded finger based on an angle between fingers and a finger length, for example. The artificial intelligence model may infer the intended gesture based on the hand direction and the unfolded finger or the folded finger, for example.

The refrigerator 1 may determine the intended gesture as any one of the first gesture for selecting the door to be opened, the second gesture for agreeing to the door to be opened, and the third gesture for denying the door to be opened based on the hand direction and the unfolded finger or the folded finger.

As described above, the refrigerator 1 of the disclosure may increase the efficiency of automatic door opening by determining the hand gesture using the artificial intelligence model.

According to an example, in operation 660, the refrigerator 1 may open the door selected based on the first gesture based on determining that the hand gesture is the first gesture for selecting the door to be opened.

The refrigerator 1 may recognize, from the first gesture, a command to open at least one door. The refrigerator 1 may select at least one door by analyzing the meaning of the first gesture. The refrigerator 1 may open the door selected based on the first gesture. For example, the door control module 150 may automatically open the selected door using the rotational force of the motor.

As such, the refrigerator 1 of the disclosure simultaneously uses the IR camera 163a and the RGB camera 163b to detect the user's hand, so that the user's hand may be recognized with high accuracy even in various environments. Further, the refrigerator 1 of the disclosure may increase the accuracy of determining the user's hand gesture by clearly grasping structural information about the user's hand via pre-processing on the hand image. Therefore, the refrigerator 1 of the disclosure may increase the convenience and efficiency of using the refrigerator 1 by automatically opening the door that meets the user's intention.

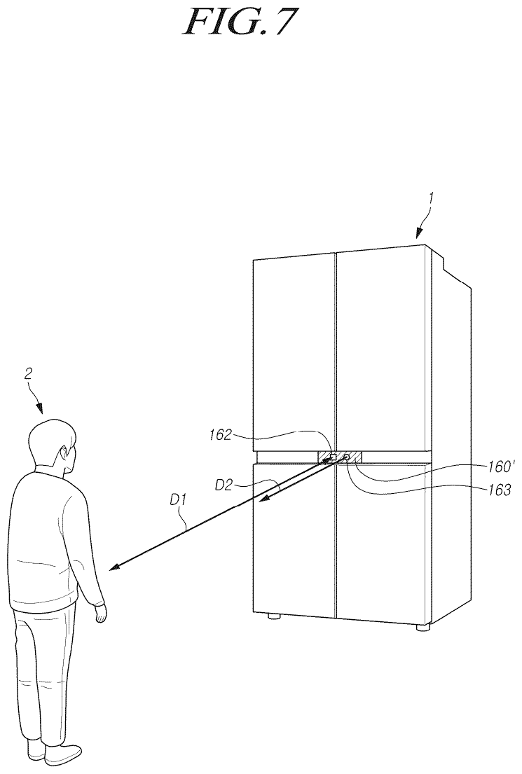

FIG. 7 is a view illustrating an operation in which a proximity sensor 162 senses the user 2's approach to the refrigerator 1 according to an embodiment of the disclosure.

In FIG. 7, the refrigerator 1 may activate the camera sensor 163 based on identifying that the user 2 is positioned within the first distance D1 from the refrigerator 1 using the proximity sensor 162.

The proximity sensor 162 may detect whether the user 2 is close to the refrigerator 1 within a predetermined distance by detecting a change in distance between the user 2 and the refrigerator 1. For example, the proximity sensor 162 may identify the user 2's approach and detect whether the user 2 is positioned within the first distance D1 from the refrigerator 1. For example, the proximity sensor 162 may include at least one of an infrared sensor, an ultrasonic sensor, a capacitive sensor, and an inductive sensor.

The refrigerator 1 may activate the camera sensor 163 based on identifying that the user 2 is positioned within the first distance D1 from the refrigerator 1. When the camera sensor 163 is activated, the camera sensor 163 may photograph the user 2 within the first distance D1. For example, the camera sensor 163 may generate an input image by photographing a portion of the body of the user 2.

The refrigerator 1 may sense the hand of the user 2 based on identifying that the user 2 is positioned within the second distance D2 shorter than the first distance D1 from the refrigerator 1 using the proximity sensor 162. For example, the refrigerator 1 may sense the hand of the user 2 using the camera sensor 163.

The camera sensor 163 may be a sensor that generates a digital image by converting light collected in a sensing area into an electrical signal. For example, the camera sensor 163 may photograph the user 2 within the first distance D1 from the refrigerator 1. For example, the first distance D1 may be substantially 0.8 m to substantially 1.2 m, although other distances are possible in other embodiments. For example, the camera sensor 163 may include at least one of a CMOS sensor, a CCD sensor, an IR camera 163a, and an RGB camera 163b.

The camera sensor 163 may photograph the hand of the user 2 within the second distance D2 from the refrigerator 1. The camera sensor 163 may sense the hand of the user 2 by simultaneously using the IR camera 163a and the RGB camera 163b. For example, the second distance D2 may be substantially 0.2 m to substantially 0.4 m, although other distances are possible in other embodiments.

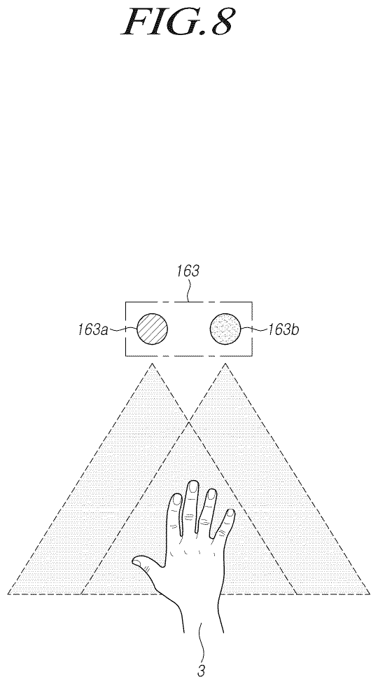

FIG. 8 is an example view illustrating a configuration of a camera sensor 163 according to an embodiment of the disclosure.

In FIG. 8, the camera sensor 163 may include an IR camera 163a and an RGB camera 163b. For example, the camera sensor 163 may use both the IR camera 163a and the RGB camera 163b to photograph the user in proximity to the refrigerator 1 and generate an input image. According to one embodiment, the camera sensor 163 may simultaneously use the IR camera 163a and the RGB camera 163b to detect the user's hand 3, thereby recognizing the user's hand 3 with high accuracy even in various environments.

The IR camera 163a may be a camera sensor 163 that generates an input image by sensing an infrared spectrum. Since the IR camera 163a may operate in an environment where there is minimal light, the user's hand 3 may be identified and photographed even in dark conditions, such as night. For example, the refrigerator 1 may generate a first input image by photographing the user's hand 3 using the IR camera 163a.

The RGB camera 163b may be a camera sensor 163 that detects red, green, and blue, which are the primary colors of light, and generates an input image based on each color. The RGB camera 163b provides high resolution and may clearly photograph detailed elements of the user's hand 3. For example, the refrigerator 1 may generate a second input image by photographing the user's hand 3 using the RGB camera 163b.

The camera sensor 163 may sense the user's hand 3 using the IR camera 163a and the RGB camera 163b simultaneously, so that the hand 3 may be sensed according to the high resolution of the RGB camera 163b in a high illumination environment (e.g., bright daytime), and the hand 3 may be sensed according to the infrared light of the IR camera 163a in a low illumination environment (e.g., dark or night).

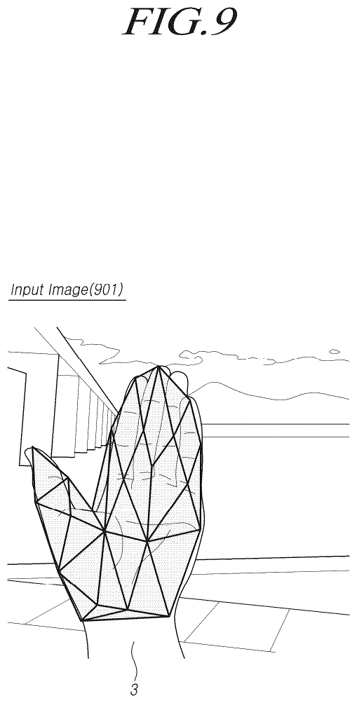

FIG. 9 is an example view illustrating an operation of identifying a hand image from an input image by a refrigerator 1 according to an embodiment of the disclosure.

In FIG. 9, the refrigerator 1 may identify the hand image 901 corresponding to the user's hand 3 from the input image obtained via the camera sensor 163. For example, the refrigerator 1 may identify the hand image 901 corresponding to the user's hand 3 from the first input image obtained from the IR camera 163a. For example, the refrigerator 1 may identify the hand image 901 corresponding to the user's hand 3 from the second input image obtained from the RGB camera 163b.

In an embodiment, the refrigerator 1 may generate a third input image by synthesizing the first input image obtained from the IR camera 163a and the second input image obtained from the RGB camera 163b. For example, the third input image may be an input image obtained by synthesizing the first input image and the second input image at the same ratio (e.g., one-to-one). The refrigerator 1 may identify the hand image 901 corresponding to the user's hand 3 from the third input image.

In an embodiment, the third input image may be an input image obtained by synthesizing the first input image and the second input image at different ratios. For example, the refrigerator 1 may synthesize the first input image and the second input image by applying a first weight to the first input image and a second weight to the second input image. For example, the first weight may increase as the ambient illuminance decreases. For example, the second weight may increase as the ambient illuminance increases.

Specifically, the refrigerator 1 may analyze each of the first input image, the second input image, and the third input image. For example, the refrigerator 1 may analyze the shape of the hand 3, the palm area, the finger length, the angle between fingers, or the like included in at least one of the first input image, the second input image, and the third input image.

The refrigerator 1 may identify the hand image included in the input image by filtering the analyzed input image. For example, in a high-illuminance environment (e.g., bright daytime), the refrigerator 1 may identify the hand image by giving the first input image a weight higher than the second or third input image. For example, in a low-illuminance environment (e.g., dark night), the refrigerator 1 may identify the hand image by giving the second input image a weight higher than the first or third input image.

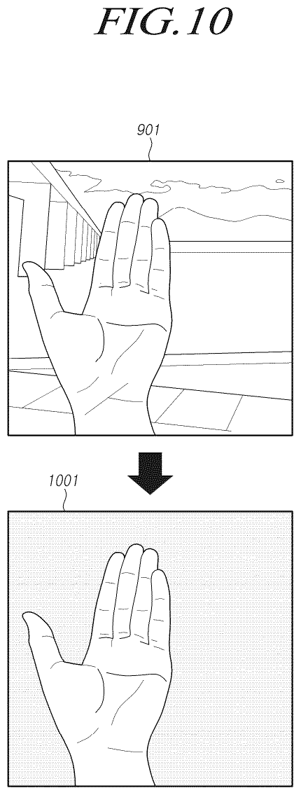

FIG. 10 is an example view illustrating first pre-processing operation of a refrigerator 1 according to an embodiment of the disclosure.

In FIG. 10, the refrigerator 1 may pre-process a hand image 901 to generate image 1001. For example, pre-processing on the hand image 901 for generating image 1001 may include at least one of noise removal in the hand image 901, emphasis on main features of the hand, standardization and normalization of the hand image 901, and shape transformation of the hand image 901.

In an embodiment, the refrigerator 1 may perform first pre-processing for removing a background image from the input image (e.g., hand image 901) while leaving the hand in the image (e.g., image 1001). The refrigerator 1 may clearly determine the hand gesture by effectively removing all background elements from the input image while leaving the hand in the image via the first pre-processing.

For example, the refrigerator 1 may remove a background image from the input image while leaving the hand in the image using an image segmentation method. The refrigerator 1 may distinguish between the hand and the background in the input image based on parameters such as color, texture, and boundary in the input image. The refrigerator 1 may remove the background image in which the parameters such as color, texture, and boundary are different from the hand image.

For example, the refrigerator 1 may remove the background image from the input image while leaving the hand in the image using a deep learning model, such as a convolutional neural network (CNN). The deep learning model may pre-learn the shape, size, and position of the hand. The deep learning model may pre-learn the surrounding environment (e.g., background) of the refrigerator 1 before the user approaches it. The deep learning model may remove the background image from the input image and extract only the hand image based on pre-learning.

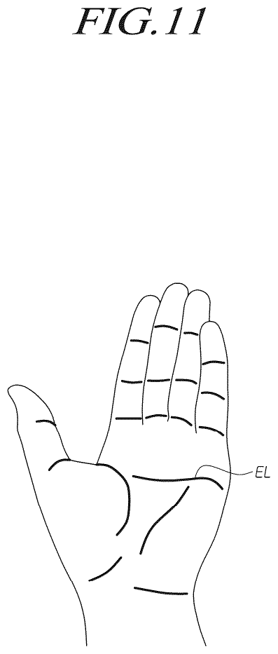

FIG. 11 is an example view illustrating second pre-processing operation of a refrigerator 1 according to an embodiment of the disclosure.

In FIG. 11, the refrigerator 1 may pre-process a hand image. For example, pre-processing on the hand image may include at least one of noise removal in the hand image, emphasis on main features of the hand, standardization and normalization of the hand image, and shape transformation of the hand image.

In an embodiment, the refrigerator 1 may perform second pre-processing of emphasizing hand wrinkles, hand joints, and fingers by performing contrast correction on the hand image. The refrigerator 1 may clearly determine the hand gesture by generating an emphasis line EL representing the features of the detailed structure of the user's hand by contrast correction on the hand image via the second pre-processing.

For example, the refrigerator 1 may emphasize fine wrinkles and joints of the hand by adjusting the contrast of the hand image in a histogram equalization method. Based on the histogram equalization, an emphasis line EL for fine wrinkles and joints of the hand may be generated in the hand image.

For example, the refrigerator 1 may enhance the contrast for a specific portion of the hand image (e.g., the boundary of the finger, the joint of the finger, and the wrinkles of the palm) in a local contrast enhancement manner. Based on the local contrast enhancement, an emphasis line EL for at least one of the boundary of the finger, the joint of the finger, and the wrinkles of the palm may be generated in the hand image.

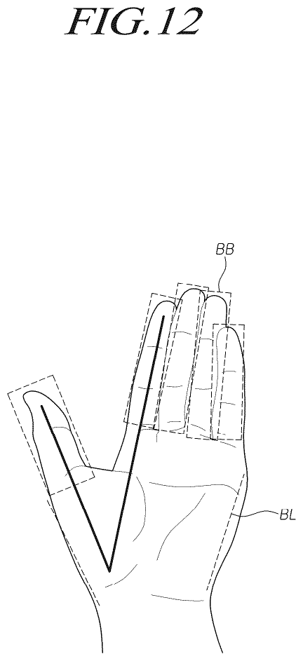

FIG. 12 is an example view illustrating third pre-processing operation of a refrigerator 1 according to an embodiment of the disclosure.

In FIG. 12, the refrigerator 1 may pre-process a hand image. For example, pre-processing on the hand image may include at least one of noise removal in the hand image, emphasis on main features of the hand, standardization and normalization of the hand image, and shape transformation of the hand image.

In an embodiment, the refrigerator 1 may perform third pre-processing of generating a bounding line BL or a bounding box BB for the thickness, length, and direction of the finger. The refrigerator 1 may clearly determine the hand gesture by grasping the exact position and direction of the finger, palm, and back of the hand in the hand image via the third pre-processing.

For example, the refrigerator 1 may detect the finger from the hand image using an image processing algorithm. The image processing algorithm may perform analysis on at least one of the color, texture, and boundary of the hand image.

The refrigerator 1 may generate the bounding box BB by calculating a minimum rectangular area of at least one finger. For example, the bounding box BB may indicate finger information including the length and thickness of the finger.

The refrigerator 1 may generate a bounding line BL along a center line of at least one finger. For example, the bounding line BL may indicate the direction of at least one finger. For example, the bounding lines BL may represent an angle between at least two fingers.

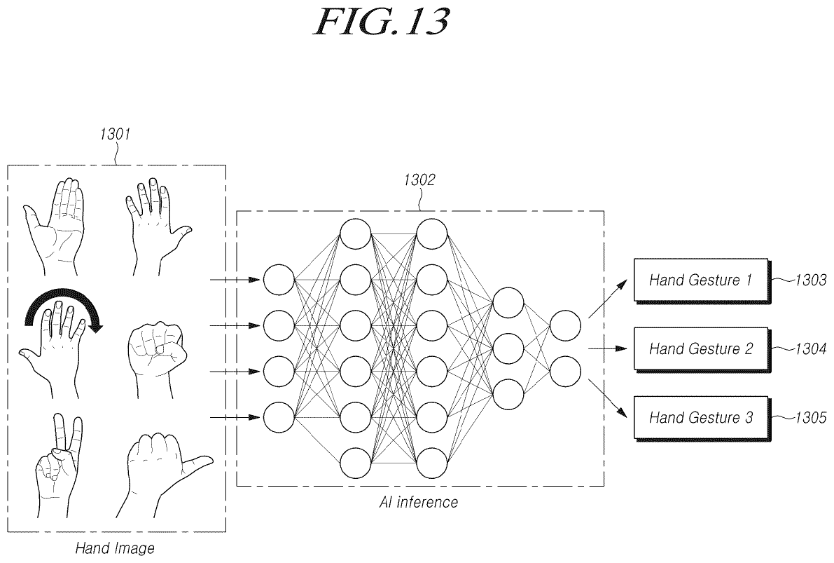

FIG. 13 is a view illustrating a process in which an artificial intelligence model determines the user's hand gesture from a hand image according to an embodiment of the disclosure.

In FIG. 13, the refrigerator 1 may determine the user's hand gesture from the hand image 1301 using an artificial intelligence model. For example, the refrigerator 1 may determine the hand gesture by inferring an intended gesture from the hand image 1301 using the artificial intelligence model that has learned the correlation between the hand image and the preset hand gesture (e.g., AI inference 1302).

The intended gesture may be a hand gesture implemented by the user via a hand by the user to provide a preset hand gesture (e.g., first gesture (e.g., hand gesture 1 1303), second gesture (e.g., hand gesture 2 1304), third gesture (e.g., hand gesture 3 1305)) to the refrigerator 1. The refrigerator 1 may infer the intended gesture from the hand image and determine the hand gesture (e.g., a first gesture, a second gesture, and a third gesture) intended to be provided by the user from the intended gesture.

Meanwhile, the artificial intelligence model used by the refrigerator 1 for AI inference 1302 of the intended gesture may be one artificial intelligence model or may be implemented as a plurality of artificial intelligence models. The artificial intelligence model may include neural networks (or artificial neural networks), and may include a statistical learning algorithm that mimics the nerves of biology in machine learning and cognitive science. The neural network may refer to all types of models which have problem-solving ability as artificial neurons (nodes) forming a network through synaptic bondings change the strength of synaptic bondings through learning. The neuron in the neural network may include a combination of weights or biases. The neural network may include one or more layers composed of one or more neurons or nodes. For example, the refrigerator 1 may include an input layer, a hidden layer, and an output layer. The neural network constituting the refrigerator 1 may infer an output to be predicted from an arbitrary input by changing the weight of the neuron through learning.

At least one processor included in the refrigerator 1 may generate a neural network, train or learn the neural network, perform a calculation based on received input data, generate an information signal based on the performance result, or retrain the neural network. The models of the neural network may include various types of models, such as CNN (Convolution Neural Network), e.g., GoogleNet, AlexNet, or VGG Network, R-CNN (Region with Convolution Neural Network), RPN (Region Proposal Network), RNN (RecuREnt Neural Network), S-DNN (Stacking-based deep Neural Network), S-SDNN (State-Space Dynamic Neural Network), Deconvolution Network, DBN (Deep Belief Network), RBM (Restricted Boltzmann Machine), Fully Convolutional Network, LSTM (Long Short-Term Memory) Network, Classification Network, but are not limited thereto. The processor may include one or more processors for performing calculation according to the models of the neural network. For example, the neural network may include a deep neural network.

The neural network may include CNN (Convolutional Neural Network), RNN (RecuREnt Neural Network), perceptron, multilayer perceptron, FF (Feed Forward), RBF (Radial Basis Network), DFF (Deep Feed Forward), LSTM (Long Short Term Memory), GRU (Gated RecuREnt Unit), AE (Auto Encoder), VAE (Variational Auto Encoder), DAE (Denoising Auto Encoder), SAE (Sparse Auto Encoder), MC (Markov Chain), HN (Hopfield Network), BM (Boltzmann Machine), RBM (Restricted Boltzmann Machine), DBN (Depp Belief Network), DCN (Deep Convolutional Network), DN (Deconvolutional Network), DCIGN (Deep Convolutional Inverse Graphics Network), GAN (Generative Adversarial Network), LSM (Liquid State Machine), ELM (Extreme Learning Machine), ESN (Echo State Network), DRN (Deep Residual Network), DNC (Differentiable Neural Computer), NTM (Neural Turning Machine), CN (Capsule Network), KN (Kohonen Network) and AN (Attention Network), but is not limited thereto. One of ordinary skill in the art may understood that any neural network may be included.

According to an embodiment of the disclosure, the at least one processor included in the refrigerator may use various artificial intelligence structures and algorithms, such as CNN (Convolution Neural Network), e.g., GoogleNet, AlexNet, or VGG Network, R-CNN (Region with Convolution Neural Network), RPN (Region Proposal Network), RNN (RecuREnt Neural Network), S-DNN (Stacking-based deep Neural Network), S-SDNN (State-Space Dynamic Neural Network), Deconvolution Network, DBN (Deep Belief Network), RBM (Restricted Boltzmann Machine), Fully Convolutional Network, LSTM (Long Short-Term Memory) Network, Classification Network, Generative Modeling, explainable AI, Continual AI, Representation Learning, AI for Material Design, BERT for natural language processing, SP-BERT, MRC/QA, Text Analysis, Dialog System, GPT-3, GPT-4, Visual Analytics for vision processing, Visual Understanding, Video Synthesis, Anomaly Detection for ResNet data intelligence, Prediction, Time-Series Forecasting, Optimization, Recommendation, and Data Creation, but is not limited thereto.

In an embodiment, the artificial intelligence model may determine the hand direction based on the hand wrinkle, the finger joint, and the thumb position. The artificial intelligence model may determine the unfolded finger or the folded finger based on the angle between fingers. The artificial intelligence model may infer the intended gesture based on the hand direction and the unfolded finger or the folded finger.

For example, the artificial intelligence model may include a first model for inferring the hand direction. The first model may determine the hand direction based on hand wrinkles, hand joints, and thumb positions. For example, the refrigerator 1 may determine whether the user's hand included in the hand image is the back of the hand or the palm based on the hand wrinkles, hand joints, and thumb positions.

For example, the artificial intelligence model may include a second model for inferring the unfolded finger or the folded finger. The second model may determine the unfolded finger or the folded finger based on the angle between fingers and the finger length. For example, the refrigerator 1 may determine which of the user's fingers included in the hand image is unfolded and which finger is folded based on the angle between fingers and the length of the finger.

For example, the artificial intelligence model may include a third model for inferring the intended gesture. The third model may infer the intended gesture based on the hand direction and the unfolded finger or the folded finger. For example, the refrigerator 1 may determine that the intended gesture is a predetermined hand gesture among the first gesture, the second gesture, and the third gesture, based on the highest degree of similarity.

Specifically, the refrigerator 1 may determine the intended gesture as any one of the first gesture (e.g., hand gesture 1 1303) for selecting the door to be opened, the second gesture (e.g., hand gesture 2 1304) for agreeing to the door to be opened, and the third gesture (e.g., hand gesture 3 1305) for denying the door to be opened, based on the hand direction and the unfolded finger or the folded finger.

The refrigerator 1 may open the door selected based on the first gesture (e.g., hand gesture 1 1303) based on determining that the hand gesture is the first gesture for selecting the door to be opened. The refrigerator 1 may recognize, from the first gesture, a command to open at least one door. The refrigerator 1 may select at least one door by analyzing the meaning of the first gesture.

The refrigerator 1 may open the door selected based on the first gesture (e.g., hand gesture 1 1303). For example, the door control module 150 may automatically open the selected door using the rotational force of the motor. According to an embodiment, the refrigerator 1 may provide a visual notification or an audible notification indicating that the selected door is opened.

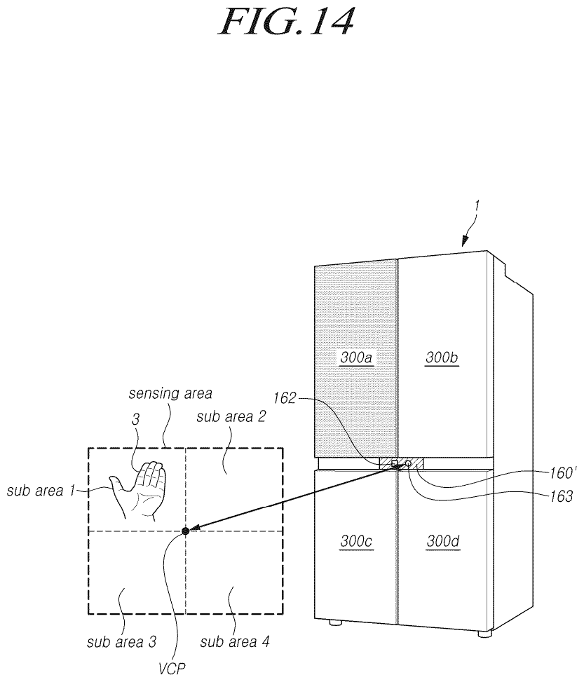

FIG. 14 is a view illustrating an operation in which a refrigerator 1 determines a door to be opened based on the position of the user's hand 3, according to an embodiment of the disclosure.

In FIG. 14, the refrigerator 1 may divide the sensing area in which the hand 3 is sensed into a plurality of sub areas based on the virtual center point VCP, and select the door to be opened from the at least one door based on the area in which the hand 3 is positioned among the plurality of sub areas.

The refrigerator 1 may set the virtual center point VCP in front of the camera sensor 163. The refrigerator 1 may divide the sensing area in which the hand 3 is sensed into a plurality of sub areas based on the number and arrangement of at least one door.

Each of the plurality of sub areas may correspond to at least one door. For example, when the refrigerator 1 includes four doors, the refrigerator 1 may divide the sensing area into four sub areas.

For example, as shown in FIG. 14, if the user's hand 3 is positioned in the first sub area, the refrigerator 1 may open the left upper door 300a corresponding to the first sub area. For example, if the user's hand 3 is positioned in the second sub area, the refrigerator 1 may open the right upper door 300b corresponding to the second sub area. For example, if the user's hand 3 is positioned in the third sub area, the refrigerator 1 may open the left lower door 300c corresponding to the third sub area. For example, if the user's hand 3 is positioned in the fourth sub area, the refrigerator 1 may open the right lower door 300d corresponding to the fourth sub area.

On the other hand, the door opening method shown in FIG. 14 (e.g., determination of the door to be opened based on the position of the user's hand 3) and the door opening method shown in FIG. 13 (e.g., determination of the door to be opened based on the hand gesture determined by the artificial intelligence model) may be complementary to each other. For example, the refrigerator 1 may determine the opened door in either the door opening method shown in FIG. 14 or the door opening method shown in FIG. 13. For example, the refrigerator 1 may determine the opened door by combining the door opening method shown in FIG. 14 and the door opening method shown in FIG. 13.

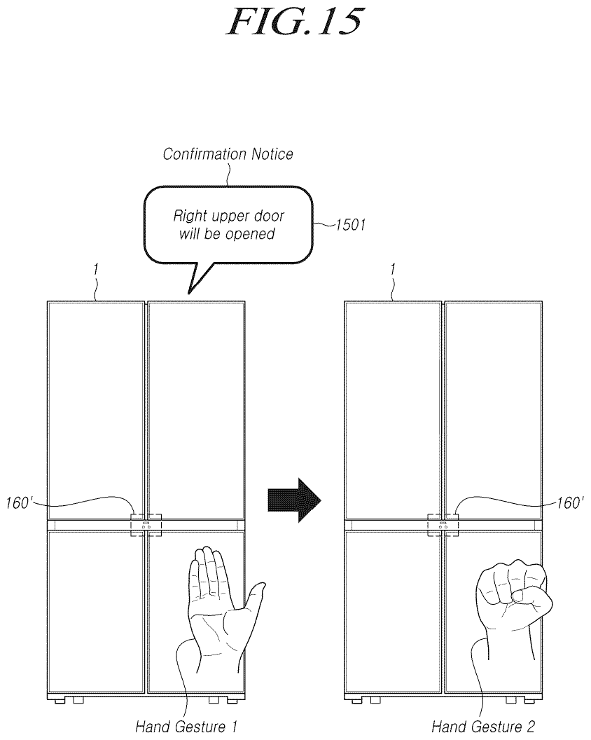

FIG. 15 is a view illustrating an identification notification for a first gesture and a second gesture according to an embodiment of the disclosure.

In FIG. 15, the refrigerator 1 may provide an identification notification of identifying the door to be opened based on the first gesture, and may open the at least one door based on the second gesture of agreeing to the door to be opened.

The refrigerator 1 may provide the identification notification for identifying the door to be opened based on determining that the hand gesture detected from the sensor group 160′ is the first gesture for selecting the door to be opened. For example, the refrigerator 1 may provide a visual notification 1501 (e.g., a message) or an audible notification (e.g., a voice output) identifying the door to be opened.

The refrigerator 1 may determine an additional hand gesture of the user after providing the identification notification for identifying the door to be opened. For example, the refrigerator 1 may determine that the user's additional hand gesture is either the second gesture for agreeing to the door to be opened or the third gesture for denying the door to be opened.

Based on the determination that the hand gesture is the second gesture for agreeing to the door to be opened, the refrigerator 1 may open the door identified by the user via the identification notification. For example, the door control module 150 may automatically open the door identified by the user using the rotational force of the motor.

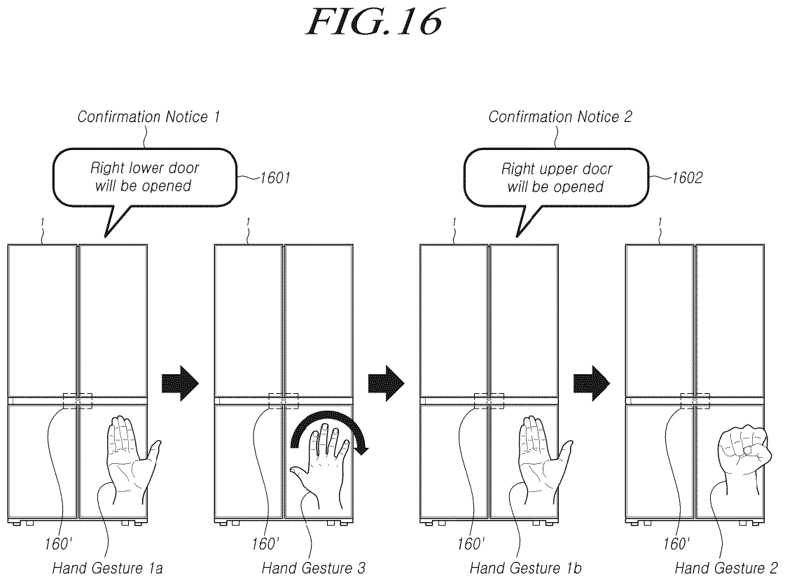

FIG. 16 is a view illustrating an identification notification for a first gesture and a third gesture according to an embodiment of the disclosure.

In FIG. 16, the refrigerator 1 may provide a first identification notification 1601 for identifying the door to be opened based on the first gesture, and may redetermine the user's hand gesture based on the third gesture for denying the door to be opened.

The refrigerator 1 may provide the first identification notification 1601 for identifying the door to be opened based on determining that the hand gesture detected from the sensor group 160′ is the first gesture for selecting the door to be opened. For example, the refrigerator 1 may provide a visual notification (e.g., a message) or an audible notification (e.g., a voice output) identifying the door to be opened.

After providing the first identification notification 1601 for identifying the door to be opened, the refrigerator 1 may determine an additional hand gesture of the user. For example, the refrigerator 1 may determine that the user's additional hand gesture is either the second gesture for agreeing to the door to be opened or the third gesture for denying the door to be opened.

Based on the determination that the hand gesture is the third gesture for denying the door to be opened, the refrigerator 1 may redetermine the hand gesture of the user. For example, the refrigerator 1 may reanalyze the meaning of the first gesture again and reselect at least one door. In this case, the refrigerator 1 may provide a second identification notification 1602 for identifying the door to be opened.

After providing the second identification notification 1602 for identifying the door to be opened, the refrigerator 1 may determine the additional hand gesture of the user. For example, the refrigerator 1 may determine that the user's additional hand gesture is either the second gesture for agreeing to the door to be opened or the third gesture for denying the door to be opened.

Based on the determination that the hand gesture is the second gesture for agreeing to the door to be opened, the refrigerator 1 may open the door identified by the user via the identification notification. For example, the door control module 150 may automatically open the door identified by the user using the rotational force of the motor.

FIG. 17 is a view illustrating a user device 4 and a server 5 connected to a refrigerator 1 according to an embodiment of the disclosure.

In FIG. 17, the refrigerator 1 may communicate with the user device 4 or the server 5. For example, the refrigerator 1 may perform communication using any of various wired or wireless communication protocols, such as Ethernet (Ethernet), GSM (global system for mobile communications), EDGE (enhanced data GSM environment), CDMA (code division multiplexing access), TDMA (time division multiplexing access), LTE (long term evolution), LTE-A (LTE advance), NR (new radio), Wi-Fi or Bluetooth. For example, the refrigerator 1 may communicate with the user device 4 or the server 5 based on a wired or wireless communication protocol.

According to an embodiment, the user device 4 may be a device capable of performing various computing functions such as a communication function, a display function, or an output function (e.g., a voice or audio output function). For example, the user device 4 may be a TV, a wearable device (e.g., earbuds, hearing aids, or head mounted display (HMD), a mobile device (e.g., a smartphone or a mobile phone), a tablet, a personal computer (PC), a desktop computer, a notebook computer, a personal digital assistant (PDA), a laptop computer, a media player, an e-book terminal, a digital broadcasting terminal, a navigation device, a kiosk, a digital camera, or a home appliance. Meanwhile, the user device 4 is not limited to the above-described devices, and may be another type of electronic device.

According to an embodiment, the user device 4 may perform communication using any various wired or wireless communication protocols such as Ethernet, GSM, EDGE, CDMA, TDMA, LTE, LTE-A, NR, Wi-Fi, or Bluetooth. For example, the user device 4 may communicate with the refrigerator 1 or the server 5 based on a wired or wireless communication protocol.

According to an embodiment, the server 5 may be connected to the refrigerator 1 and/or the user device 4. For example, the server 5 may be a cloud server. According to an example, the server 5 may receive sensing data or setting data from the refrigerator 1 and/or the user device 4. For example, the server 5 may store sensing data or setting data or transmit it to the refrigerator 1 and/or the user device 4.

In an embodiment, the user may change a control operation according to a hand gesture. For example, the user may change the first gesture for selecting the door to be opened. For example, the user may change the second gesture for agreeing to the door to be opened. For example, the user may change the third gesture for denying the door to be opened.

According to an example, the refrigerator 1 may change a control operation according to the hand gesture based on the user's setting via at least one application of the user device 4. For example, the user device 4 may provide an application that changes at least one of the first gesture, the second gesture, and the third gesture. The user may change at least one of the first gesture, the second gesture, and the third gesture using the application of the user device 4.

According to an example, the refrigerator 1 may change the control operation according to the hand gesture based on the user's setting for the hand image identified via the camera sensor 163. For example, the refrigerator 1 may provide a control operation change mode. In the control operation change mode, the user may change at least one of the first gesture, the second gesture, and the third gesture by inputting a hand image via the camera sensor 163.

In an embodiment, the refrigerator 1 may store the hand image in the server 5, learn the user's hand features from the hand image using the at least one artificial intelligence model, and identify the hand image corresponding to the user's hand from the input image based on the user's hand features.

For example, the refrigerator 1 may store the hand image in the server 5 by transmitting the hand image identified from the input image to the server 5. As the hand image is cumulatively stored in the server 5, a database of the user's hand may be generated.

The refrigerator 1 may analyze at least one of the shape, size, wrinkle, and finger length of the hand from the database for the user's hand stored in the server 5. For example, the refrigerator 1 may use at least one artificial intelligence model to learn unique hand features that are distinguished from other users' hands, such as the length ratio between the user's fingers, the position of the user's hand's dots or scars, and the shape of the user's fingernails.

The refrigerator 1 may quickly and accurately identify the hand image from the input image for the user's hand based on the learned hand features.

In an embodiment, the refrigerator 1 may determine the user feature based on at least one of the input image or the hand image, and transmit a notification indicating a limited user access to the user device 4 based on the user feature.

The refrigerator 1 may determine user features from the input image or the hand image obtained based on the camera sensor 163. For example, the refrigerator 1 may determine the user features by analyzing the hand size, hand wrinkles, the ratio between the palm and fingers, the color of the hand, or the like from the hand image. For example, the user feature may include at least one of the gender or age of the user.

The refrigerator 1 may transmit the notification indicating the limited user access to the user device 4 based on user features. For example, the refrigerator 1 may detect the access of a child user and transmit a notification indicating the access of the child user to the user device 4. For example, the refrigerator 1 may detect the approach of an elderly user and transmit a notification indicating the approach of the elderly user to the user device 4. According to an embodiment, when it is determined that the user is a limited user based on user features, the refrigerator 1 may deactivate the automatic door opening function.

According to one or more embodiments, the AI inference 1302 may be performed by the refrigerator 1, the user device 4, and/or the server 5.

As such, the refrigerator 1 of the disclosure simultaneously uses the IR camera 163a and the RGB camera 163b to detect the user's hand, so that the user's hand may be recognized with high accuracy even in various environments. Further, the refrigerator 1 of the disclosure may increase the accuracy of determining the user's hand gesture by clearly grasping structural information about the user's hand via pre-processing on the hand image. Therefore, the refrigerator 1 of the disclosure may increase the convenience and efficiency of using the refrigerator 1 by automatically opening the door that meets the user's intention. However, since this has been described above, no duplicate description is given.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to embodiments of the disclosure, a refrigerator may comprise at least one storage compartment, at least one door for opening/closing the at least one storage compartment, a door control module for controlling to open or close the at least one door, a sensor unit including a proximity sensor and a camera sensor, at least one processor including processing circuitry, and memory including one or more storage mediums storing instructions that, when executed by at least one processor individually or collectively, cause the refrigerator to perform operations. The operations may include activating the camera sensor based on identifying that a user is positioned within a first distance from the refrigerator using the proximity sensor, obtaining an input image via the camera sensor based on identifying that the user is positioned within a second distance shorter than the first distance from the refrigerator using the proximity sensor, identifying a hand image corresponding to a hand of the user from the input image, performing pre-processing on the hand image, determining a hand gesture of the user from the hand image, and controlling the door control module to open a door of the at least one door selected responsive to a first gesture based on determining that the hand gesture is the first gesture for selecting the door to be opened.

In an embodiment, the instructions are configured to, when executed by at least one processor individually or collectively, cause the refrigerator to perform at least one of first pre-processing for removing a background image from the input image while leaving the hand image, second pre-processing for emphasizing a hand wrinkle, a hand joint, and a finger by performing contrast correction on the hand image, and third pre-processing for generating a bounding line or a bounding box for a thickness, length, and direction of the finger.

In an embodiment, the camera sensor may include an infrared (IR) camera and a red-green-blue (RGB) camera. The instructions are configured to, when executed by at least one processor individually or collectively, cause the refrigerator to generate a third input image by synthesizing a first input image obtained from the IR camera and a second input image obtained from the RGB camera.

In an embodiment, the instructions are configured to, when executed by at least one processor individually or collectively, cause the refrigerator to synthesize the first input image and the second input image by applying a first weight to the first input image and a second weight to the second input image. The first weight may increase as the ambient illuminance decreases. The second weight may increase as the ambient illuminance increases.

In an embodiment, the instructions are configured to, when executed by at least one processor individually or collectively, cause the refrigerator to analyze each of the first input image, the second input image, and the third input image, and identify the hand image included in the input image by filtering the analyzed input image.

In an embodiment, the instructions are configured to, when executed by at least one processor individually or collectively, cause the refrigerator to determine the hand gesture by inferring an intended gesture from the hand image using at least one artificial intelligence model that has learned a correlation between the hand image and a preset hand gesture.

In an embodiment, the at least one artificial intelligence model may include a first model inferring a hand direction based on a hand wrinkle, a hand joint, and a thumb position, a second model inferring an unfolded finger or a folded finger based on an angle between fingers and a finger length, and a third model inferring the intended gesture based on the hand direction and the unfolded finger or the folded finger.

In an embodiment, the instructions are configured to, when executed by at least one processor individually or collectively, cause the refrigerator to divide a sensing area where the hand is sensed into a plurality of sub areas with respect to a virtual center point, and select the door to be opened among the at least one door based on an area where the hand is positioned among the plurality of sub areas.

In an embodiment, the instructions are configured to, when executed by at least one processor individually or collectively, cause the refrigerator to provide a notification for identifying the door to be opened based on the first gesture, and open the at least one door based on a second gesture for agreeing to the door to be opened.

In an embodiment, the instructions are configured to, when executed by at least one processor individually or collectively, cause the refrigerator to provide a notification for identifying the door to be opened based on the first gesture, and redetermine the hand gesture of the user based on a third gesture for denying the door to be opened.

In an embodiment, the instructions are configured to, when executed by at least one processor individually or collectively, cause the refrigerator to change a control operation according to the hand gesture based on settings for the user via at least one application of a user device.

In an embodiment, the instructions are configured to, when executed by at least one processor individually or collectively, cause the refrigerator to change a control operation according to the hand gesture based on settings for the user on the hand image identified via the camera sensor.

In an embodiment, the instructions are configured to, when executed by at least one processor individually or collectively, cause the refrigerator to store the hand image in a server, learn the hand feature for the user from the hand image using at least one artificial intelligence model, and identify the hand image corresponding to the hand of the user from the input image based on the hand feature for the user.

In an embodiment, the instructions are configured to, when executed by at least one processor individually or collectively, cause the refrigerator to determine a user feature based on at least one of the input image or the hand image, and transmit a notification indicating a limited user's access to a user device based on the user feature.

In an embodiment, the instructions are configured to, when executed by at least one processor individually or collectively, cause the refrigerator to increase a hand recognition rate by sensing the hand of the user using an infrared (IR) camera and a red-blue-green (RGB) camera simultaneously. The instructions are configured to, when executed by the processor individually or collectively, cause the refrigerator to increase a determination accuracy of the hand gesture by performing pre-processing on the hand image. The instructions are configured to, when executed by the processor individually or collectively, cause the refrigerator to increase an efficiency of automatic door opening by determining the hand gesture using an artificial intelligence model.

According to embodiments of the disclosure, a method for controlling a refrigerator may comprise activating a camera sensor based on identifying that a user is positioned within a first distance from the refrigerator using a proximity sensor, obtaining an input image via the camera sensor based on identifying that the user is positioned within a second distance shorter than the first distance from the refrigerator using the proximity sensor, identifying a hand image corresponding to a hand of the user from the input image, performing pre-processing on the hand image, determining a hand gesture of the user from the hand image, and opening a door of the at least one door selected based on a gesture responsive to determining that the hand gesture is the gesture for selecting the door to be opened.

In an embodiment, performing the pre-processing on the hand image may perform at least one of first pre-processing for removing a background image from the input image while leaving the hand image, second pre-processing for emphasizing a hand wrinkle, a hand joint, and a finger by performing contrast correction on the hand image, and third pre-processing for generating a bounding line or a bounding box for a thickness, length, and direction of the finger.

In an embodiment, the camera sensor may include an infrared (IR) camera and a red-green-blue (RGB) camera. Identifying the hand image corresponding to the hand of the user may include generating a third input image by synthesizing a first input image obtained from the IR camera and a second input image obtained from the RGB camera.

In an embodiment, identifying the hand image corresponding to the hand of the user may include analyzing each of the first input image, the second input image, and the third input image, and identifying the hand image included in the input image by filtering the analyzed input image.

In an embodiment, determining the hand gesture of the user from the hand image may include determining the user's hand gesture from the hand image includes determining the hand gesture by inferring an intended gesture from the hand image using at least one artificial intelligence model that has learned a correlation between the hand image and a preset hand gesture.

In an embodiment, the at least one artificial intelligence model may include a first model inferring a hand direction based on a hand wrinkle, a hand joint, and a thumb position, a second model inferring an unfolded finger or a folded angle based on an angle between fingers and a finger length, and a third model inferring the intended gesture based on the hand direction and the unfolded finger or the folded finger.

What is claimed is:

1. A refrigerator, comprising:
at least one storage compartment;
at least one door for opening/closing the at least one storage compartment;
a door control module for controlling to open or close the at least one door;
a sensor unit including a proximity sensor and a camera sensor;
at least one processor including processing circuitry; and
memory including one or more storage mediums storing instructions that, when executed by at least one processor individually or collectively, cause the refrigerator to:
activate the camera sensor based on identifying that a user is positioned within a first distance from the refrigerator using the proximity sensor;
obtain an input image via the camera sensor based on identifying that the user is positioned within a second distance shorter than the first distance from the refrigerator using the proximity sensor;
identify a hand image corresponding to a hand of the user from the input image;
perform pre-processing on the hand image;
determine a hand gesture of the user from the hand image; and
control the door control module to open a door of the at least one door selected based on a first gesture responsive to determining that the hand gesture is the first gesture for selecting the door to be opened.

2. The refrigerator of claim 1, wherein the instructions are configured to, when executed by at least one processor individually or collectively, cause the refrigerator to:
perform at least one of:
first pre-processing for removing a background image from the input image while leaving the hand image;
second pre-processing for emphasizing a hand wrinkle, a hand joint, and a finger by performing contrast correction on the hand image; and
third pre-processing for generating a bounding line or a bounding box for a thickness, length, and direction of the finger.

3. The refrigerator of claim 1, wherein the camera sensor includes an infrared (IR) camera and a red-green-blue (RGB) camera, and
wherein the instructions are configured to, when executed by at least one processor individually or collectively, cause the refrigerator to generate a third input image by synthesizing a first input image obtained from the IR camera and a second input image obtained from the RGB camera.

4. The refrigerator of claim 3, wherein the instructions are configured to, when executed by at least one processor individually or collectively, cause the refrigerator to:
synthesize the first input image and the second input image by applying a first weight to the first input image and a second weight to the second input image, and
wherein the first weight increases as an ambient illuminance decreases, and
wherein the second weight increases as the ambient illuminance increases.

5. The refrigerator of claim 3, wherein the instructions are configured to, when executed by at least one processor individually or collectively, cause the refrigerator to:
analyze each of the first input image, the second input image, and the third input image; and
identify the hand image included in the input image by filtering the analyzed input image.

6. The refrigerator of claim 1, wherein the instructions are configured to, when executed by at least one processor individually or collectively, cause the refrigerator to determine the hand gesture by inferring an intended gesture from the hand image using at least one artificial intelligence model that has learned a correlation between the hand image and a preset hand gesture.

7. The refrigerator of claim 6, wherein the at least one artificial intelligence model includes:
a first model inferring a hand direction based on a hand wrinkle, a hand joint, and a thumb position;
a second model inferring an unfolded finger or a folded finger based on an angle between fingers and a finger length; and
a third model inferring the intended gesture based on the hand direction and the unfolded finger or the folded finger.

8. The refrigerator of claim 6, wherein the instructions are configured to, when executed by at least one processor individually or collectively, cause the refrigerator to:
divide a sensing area where the hand is sensed into a plurality of sub areas with respect to a virtual center point; and
select the door to be opened among the at least one door based on an area where the hand is positioned among the plurality of sub areas.

9. The refrigerator of claim 1, wherein the instructions are configured to, when executed by at least one processor individually or collectively, cause the refrigerator to:
provide a notification for identifying the door to be opened based on the first gesture; and
open the at least one door based on a second gesture for agreeing to the door to be opened.

10. The refrigerator of claim 1, wherein the instructions are configured to, when executed by at least one processor individually or collectively, cause the refrigerator to:
provide a notification for identifying the door to be opened based on the first gesture; and
redetermine the hand gesture of the user based on a third gesture for denying the door to be opened.

11. The refrigerator of claim 1, wherein the instructions are configured to, when executed by at least one processor individually or collectively, cause the refrigerator to change a control operation according to the hand gesture based on settings for the user via at least one application of a user device.

12. The refrigerator of claim 1, wherein the instructions are configured to, when executed by at least one processor individually or collectively, cause the refrigerator to change a control operation according to the hand gesture based on settings for the user on the hand image identified via the camera sensor.

13. The refrigerator of claim 1, wherein the instructions are configured to, when executed by at least one processor individually or collectively, cause the refrigerator to:
store the hand image in a server;
learn a hand feature for the user from the hand image using at least one artificial intelligence model; and
identify the hand image corresponding to the hand of the user from the input image based on the hand feature for the user.

14. The refrigerator of claim 1, wherein the instructions are configured to, when executed by at least one processor individually or collectively, cause the refrigerator to:
determine a user feature based on at least one of the input image or the hand image; and
transmit a notification indicating a limited user's access to a user device based on the user feature.

15. The refrigerator of claim 1, wherein the instructions are configured to, when executed by at least one processor individually or collectively, cause the refrigerator to:
increase a hand recognition rate by sensing the hand of the user using an infrared (IR) camera and a red-blue-green (RGB) camera simultaneously;
increase a determination accuracy of the hand gesture by performing pre-processing on the hand image; and
increase an efficiency of automatic door opening by determining the hand gesture using an artificial intelligence model.

16. A method for controlling a refrigerator including at least one door, a door control module, a proximity sensor, and a camera sensor, the method comprising:
activating the camera sensor based on identifying that a user is positioned within a first distance from the refrigerator using the proximity sensor;
obtaining an input image via the camera sensor based on identifying that the user is positioned within a second distance shorter than the first distance from the refrigerator using the proximity sensor;
identifying a hand image corresponding to a hand of the user from the input image;
performing pre-processing on the hand image;
determining a hand gesture of the user from the hand image; and
opening a door of the at least one door selected based on a gesture responsive to determining that the hand gesture is the gesture for selecting the door to be opened.

17. The method of claim 16, wherein performing the pre-processing on the hand image performs at least one of:
first pre-processing for removing a background image from the input image while leaving the hand image;
second pre-processing for emphasizing a hand wrinkle, a hand joint, and a finger by performing contrast correction on the hand image; and
third pre-processing for generating a bounding line or a bounding box for a thickness, length, and direction of the finger.

18. The method of claim 16, wherein the camera sensor includes an infrared (IR) camera and a red-green-blue (RGB) camera, and
wherein identifying the hand image corresponding to the hand of the user includes generating a third input image by synthesizing a first input image obtained from the IR camera and a second input image obtained from the RGB camera.

19. The method of claim 18, wherein identifying the hand image corresponding to the hand of the user includes:
analyzing each of the first input image, the second input image, and the third input image; and
identifying the hand image included in the input image by filtering the analyzed input image.

20. The method of claim 16, wherein determining the hand gesture of the user from the hand image includes determining the hand gesture by inferring an intended gesture from the hand image using at least one artificial intelligence model that has learned a correlation between the hand image and a preset hand gesture.
